(19) United States
(12) Patent Application Publication
(10) Pub. No.: US 2012/0104215 A1
(43) Pub. Date: May 3, 2012

(54) Drum Protector and Stacking Device

(76) Inventors: Tony Benach, San Diego, CA (US); Casey Hopkins, Portland, OR (US)

(21) Appl. No.: 13/031,157

(22) Filed: Feb. 18, 2011

Related U.S. Application Data
(63) Continuation of application No. 61/305,613, filed on Feb. 18, 2010.

(51) Int. Cl. F16M 13/00

(52) U.S. Cl. 248/346.5

(57) ABSTRACT

The present invention relates generally to an apparatus which provides protection for percussion instruments and more specifically to device that protects the underlying musical drum instrument and its components, such as drum head and drum rim or hoop and parts of individual drums, when the drums are stacked one upon the other. In providing such protection, the invention is placed between stacked drum sets and supplies a cushion between the stacked drum and the drumhead of the drum thus prolonging the life of the drumhead and drum rim or hoop, protecting them from damage. The invention works by providing protection both during storage and playing of the instrument.

### FIELD OF THE INVENTION

This application claims the benefit of U.S. provisional application Ser. No. 61/305,613 filed Feb. 18, 2010, the substance of which is incorporated herein in its entirety.

The present invention relates generally to an apparatus which provides protection for percussion instruments and more specifically to device that protects the underlying musical drum instrument and its components, such as drum head and drum rim or hoop and parts of individual drums, when the drums are stacked one upon the other. In providing such protection, the invention is placed between stacked drum sets and provides a cushion between the stacked drum and the drumhead of the drum thus prolonging the life of the drumhead and drum rim or hoop, protecting them from damage.

### BACKGROUND INFORMATION

Modern musical instruments are complex and expensive pieces of equipment heavily relied upon to provide consistent and reliable sound. Several inventions have sought to protect such instruments from undue wear and tear through development of protective devices placed in and around different musical instruments. By far, the instrument most prone to shock, are the percussive instruments which endure nearly constant pounding during use. During play and often in storage or set up for display, percussion instruments are subject to significant potential for damage when musicians stack one drum set on another in order to provide the best “setup” for the musician during play or storage. In the course of play, drum sets bang against one another becoming damaged over time resulting in the necessity of having to replace drum rims or in more extreme cases, the entire drum set must be replaced if the drum falls and is damaged.

A significant portion of the prior art seeks to provide devices designed to protect drum sticks from wear and tear however, such devices typically protect drum sticks and the like rather than the more expensive drum sets themselves. Moreover, a device that provides protection of such instruments while also providing the ability to be incorporated to assist in stacking drum sets is a significant shortcoming in the art. In attempting to address the shortcomings of the prior art, the present invention provides a device that acts to protect percussion instruments and works as an integral part to provide stacking of drum sets during use. In doing so, the present invention provides solutions not realized with previous devices.

For example, U.S. Pat. No. 6,166,311 issued to Barrickman discloses a drum hoop with a protective edge that assists in protecting percussion instruments during use. Specifically, the device has an inwardly directed edge which partially covers the bearing edge of the drum shell and protects the edge of the drum shell such that contact with the drum stick is prevented. The device also purports to provide sufficient to coverage to prevent accidental damage and provides proper tensioning of the drum head on the drum shell.

Similarly, U.S. Pat. No. 5,261,309 to Valen purports to address the problem of drum stick breakage or excessive wear, due to impact against drum metallic rims and discloses a wear pad assembly that is attachable to a drum structure. Specifically, the invention provides a drum stick wear pad that is attachable to a drum rim that includes a non-metallic hard pad elongated with a primary curvature in the direction of the drum arcuate rim.

The invention further provides a rigid mount for the pad to hold the pad above the rim with the mount configured to be attached to the drum's rim structure. The device however, fails to address the problem of preventing damage to drum structures caused by banging and other shocks when drums are placed one on top of the other or from normal wear and tear associated with playing multiple drums.

U.S. Pat. No. 5,986,196 to Behrenfeld describes an impact pad for a drum head with a unique irregular shape that protects the drum head while allowing it to smoothly flex and in doing so, reduces drum head distortion resulting in an enhanced sound projection. However, as with the invention previously discussed, the '196 patent fails to address the problem of providing protection to expensive percussive instruments from shock damage occurring during play.

It is therefore, a primary object of the present invention to provide a device that protects an underlying musical percussion instrument and its components such as the drum head, rim or hoop and other parts of the drum when the drums are stacked one upon the other during use or storage. The invention also provides a cushion between the stacked drum and the drumhead of the drum, such as for example, the drum rim or hoop from damage during play. The device will consist of two specific sizes, one size to fit the bass drum and the other sizes to fit all other drums.

### SUMMARY OF THE INVENTION

The present invention is directed to a protective drum stacking device comprising, a body portion made of a essentially a durable, semi-flexible material, and a top section which is molded to hold various sized drums in place, wherein, the top section is formed into peaks and valleys to hold the desired drum in place. The invention provides a device wherein one or more of the protective drum stacking devices fit onto a drum head and allows placement of a second drum head on top of the first, preventing any damage to either drum, during either storage or play of the drums.

The drum stacking device of the present invention as contemplated herein is composed essentially of rubber, synthetic rubber, Teflon or any appropriate thermoplastic elastomer. The device also as contemplated is prepared in two sizes, a smaller device for smaller sized drums and likewise, a larger device for larger drum heads. The body portion of the smaller drum protection device measures approximately 3.97 inches in length, 1.25 inches in height, 0.50 inches peak to peak and 1.25 to 1.58 inches wide. The body portion of the larger drum protection device measures approximately 7.25 inches in length, 2.13 inches in height, 0.50 inches peak to peak and 1.25 to 1.58 inches wide.

### BRIEF DESCRIPTION OF THE DRAWINGS

FIG. 1 depicts the basic configuration of a smaller sized drum stacker and protection device, for smaller sized drums, in its entirety. Specifically, the illustration shows an above angle view of the device in which the stacker “peaks” and “valleys” as well as other portions of the device are located. In the depiction the device has four valleys in which a drum rim may be placed.

FIG. 2 depicts the basic configuration of a smaller sized drum stacker and protection device for smaller sized drums and drum sets. Specifically, the illustration provides a side-view of the device in which peaks and valleys of the device are visible.

FIG. 3 illustrates the basic configuration of a larger sized drum stacker and protection device, for larger sized drums, its entirety. The embodiment otherwise known as a “bass drum stacker” shows an above angle view of the device in which the stacker “peaks” and “valleys” as well as other portions of the device are located. In the depiction the device has seven valleys in which a drum rim may be placed.

FIG. 4 depicts the basic configuration of the bass drum stacker (larger sized drum stacker) and protection device for larger sized drums and drum sets. Specifically, the illustration provides a side-view of the device in which peaks and valleys of the device are visible.

FIG. 5 illustrates how the stacker and protection device fits onto and between drums. Specifically, the drum stacker is fitted onto a drum rim by engaging a drum stacker slide channel in which the rim fits. A second drum is shown as it fits on top of the stacker while engaged with a lower drum.

FIG. 6 illustrates multiple drum stacking devices of the invention used to protect 4 separate drums. Specifically, the lowest drum, a base drum, is fitted with an appropriate number of bass drum stacker devices to accommodate placement of a second drum on top of the lower drum. The second drum is fitted with an appropriate number of stackers in order to accommodate placement of a third drum. Finally, the third drum is fitted with an appropriate number of smaller (drum stacker) stacking devices in order to accommodate a fourth drum.

### DETAILED DESCRIPTION OF THE INVENTION

The invention relates to a device that provides percussion instruments, especially large bass drums as well as smaller drums, protection against damage due to stacking one drum one on top of the other. The invention further provides a small drum stacker for smaller sized drums and a large size drum stacker, commonly referred to as a bass drum stacker.

In a preferred embodiment of the invention, the drum stacker and the bass drum stacker is utilized in a variety of working situations including drum storage, use during play or in transportation of a drum or drum set.

In a preferred embodiment, the smaller sized drum stacker measures 3.97 inches in length and 1.25 inches at its greatest height. Drum stacker peaks measure 0.05 inches peak to peak. The drum stacker slide channel 3 of the smaller version of the invention measures 0.75 inches in length, while the channel itself is 0.19 inches wide. Further, both the smaller and larger versions of the drum stacker measure 1.25 to 1.58 inches wide.

The preferred embodiment will be prepared by materials known and unknown in the art as appropriate and include for example, foam, plastic, silicone, rubber, Teflon, synthetic rubber and other similar materials.

In a preferred embodiment, the larger drum stacker also referred to as a bass drum stacker, measures 7.25 inches in length and 2.13 inches in height. The bass drum slide channel 11 is 1.38 inches in length with the channel measuring 0.25 inches wide. The bass drum stacker is prepared with 7 or more drum stacker peaks to accommodate different sized drum rims and heads.

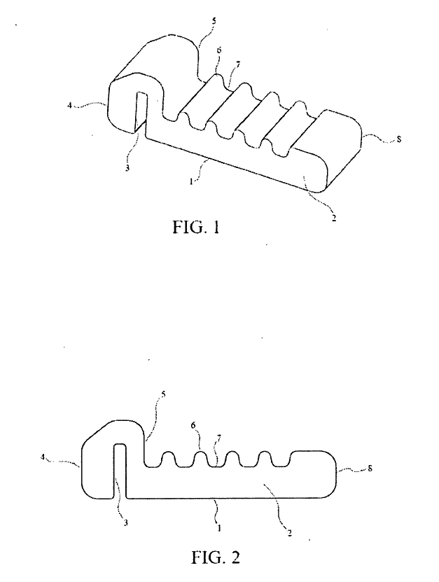

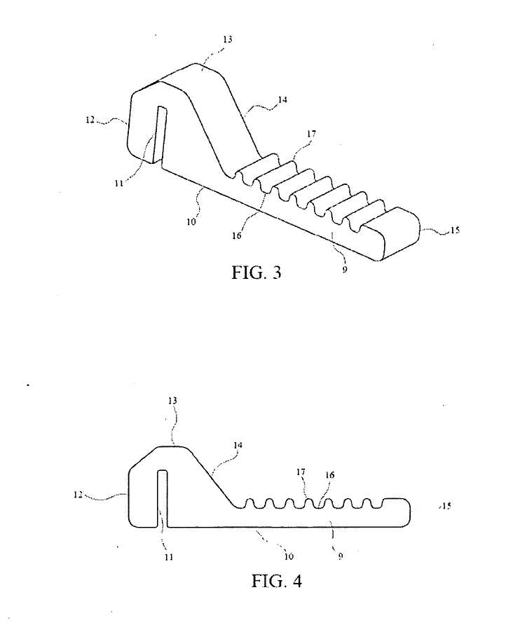

The term “drum stacker” as used herein refers to either the smaller or larger sized inventions, except when the drum stacker is referred to as a “bass drum stacker” or the “larger sized” drum stacker. In such an instance, reference is made to only the larger version of the invention described herein. For example, FIGS. 1 and 2 depict the drum stacker (small version) and FIGS. 3 and 4 illustrate the “bass drum stacker” or the larger version of the invention.

The term “semi-flexible” as used herein refers to the quality of a material that is substantially solid in form however provides a small measure of flexibility when placed under pressure or stress, without breaking. Materials with such character include for example, rubber, Teflon, synthetic rubber and other similar polymer materials.

The term “durable” as used herein refers to the quality of a material wherein the material undergoes small stresses and pressures without breaking. For example, a block of Teflon or rubber includes materials that are durable as contemplated herein.

Various methods of manufacture as known in the art may be employed however, the following description provides a preferred method of manufacturing.

### CURRENT METHOD OF PRODUCTION

A Sheet measuring of 4-LB Cross Linked Laminated Polyethylene measuring approximately 8′×4′×2″ are set inside of a machine and precisely cut into shape by using pressurized water and a water jet which is forced out of the water jet machine in a very thin stream, very fast and under high pressure with the ability to cut through the material used to make the product. To fully pressurize the water, the water jet cutting process utilizes an intensifier pump, which creates the ultra-high pressure (over 50,000 psi) water pressure required for cutting hard materials.

The Intensifier Pump employs a hydraulic pressure water disbursement system which forces water out at a sufficient velocity to cut through heavy metals and other materials such as those used in the present invention. A large horsepower motor is employed to drive a hydraulic pump, creating hydraulic pressure which powers a piston in a cylinder. The hydraulic pressure is amplified by the ratio of a larger hydraulic cylinder pushing a smaller piston into a cylinder filled with water, thus creating the ultra-high water pressure.

The pressurized water is delivered to a cutting head by either high pressure tubing or hose. At the cutting head, the high pressure water is applied to an orifice, or a smaller tip, with a typical diameter ranging from 0.005″ to 0.020″. This orifice is composed of diamond or sapphire, to resist abrasion of the high pressure water. The orifice defines and creates the water stream which cuts through the material.

### POTENTIAL OTHER METHODS FOR MASS PRODUCTION

Extrusion is a process used to create objects of a fixed cross-sectional profile. A material, such as those in the present invention, is pushed or drawn through a die of the desired cross-section. The two main advantages of this process over other manufacturing processes are its ability to create very complex cross-sections and work materials that are brittle, because the material only encounters compressive and shear stresses. It also forms finished parts with an excellent surface finish.

Extrusion may be continuous (theoretically producing indefinitely long material) or semi-continuous (producing many pieces). The extrusion process can be done with either heated or cooled material. Extrusion is a process which uses a mold which is made of metal shaped to the specific measurements of the product. The mold is open on one end and has a small hole on the other end. Material in a liquid form is pushed into the mold from the small end. This liquid is then pushed out of the large open end of the mold into long sheets. The process of pushing the material from the small opening out the large opening makes the material take the shape of the mold. The liquid is immediately pushed into an oven like device which hardens the material as the material exits the large end. Since the liquid is being pushed through the mold it comes out in the shape of the mold, then becomes hard and stays in that shape in desired lengths. The lengths of material are then cut by a device such as for example, a large razor blade, into the desired width of the product.

Hollow cavities within extruded material cannot be produced using a simple flat extrusion die, because there would be no way to support the center barrier of the die. Instead, the die assumes the shape of a block with depth, beginning first with a shape profile that supports the center section. The die shape then internally changes along its length into the final shape, with the suspended center pieces supported from the back of the die.

Other methods as known in the art may also be employed in production of the invention.

Turning now to the substance of FIGS. 1 to 6 and the preferred embodiments of the drum stacker. FIGS. 1 and 2 illustrate the configuration of the smaller version of the drum stacker from top-side and side-angle perspectives respectively. Specifically, FIG. 1 illustrates drum stacker peaks 6 and valleys 7 designed to hold drums in place. A drum rim is fitted into the drum stacker slide channel 3 where the drum rests during use. The drum stacker heel 2, drum stacker undersurface 1, drum stacker foot 8 and drum stacker head 4, act to support the drum and its components. The drum stacker face 5 acts to prevent drums from slipping off and hold them securely in place.

FIGS. 3 and 4 illustrate the configuration of the smaller version of the drum stacker from top-side and side-angle perspectives respectively. Specifically, FIG. 3 illustrates the bass drum stacker peaks 17 and valleys 16 designed to hold drums in place. A drum rim is fitted into the bass drum stacker slide channel 11 where the drum rests during use. The bass drum stacker foot 15, side surface 9 and undersurface 10 act to support the drum and its components. The bass drum stacker face 14 acts to prevent drums from slipping off and hold them securely in place. The bass drum stacker cap 13 acts to support larger drums and drum sets while in use.

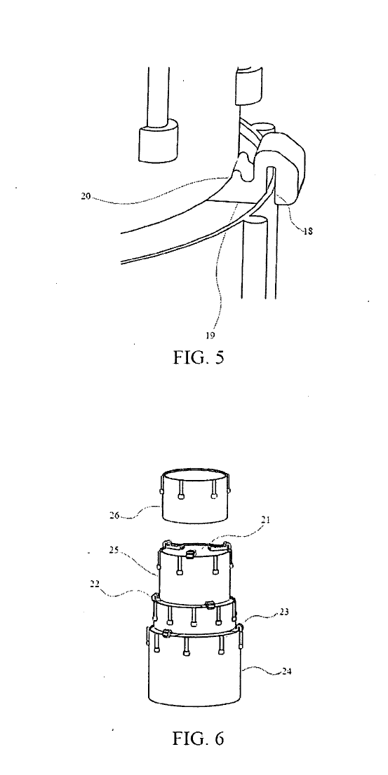

FIG. 5 illustrates how one drum fits on top of another using either the drum stacker or the bass drum stacker. Specifically, the rim 18 is engaged in the drum stacker slide channel 3, 11 with the drum head 19 resting on the drum stacker undersurface 1, 10. The upper drum is seated in a drum stacker valley 7, 16 and is situated to stay in place. FIG. 6 shows the configuration of several drums seated one on top of the other using the stacker devices of the present invention. Specifically, a bass drum 24 is fitted with a bass drum stacker 23. A drum stacker is fitted on the upper drum 22 upon which rest a third drum 25. In this illustration, three drum stackers are shown fitted onto the third drum 25 upon which a fourth drum is fitted 26.

In a preferred embodiment, the drum stacker is manufactured by injecting a heated and viscous elastomer into an appropriately sized mold, followed by cooling. The composition of the elastomer can be any polymer based material, synthetic rubber natural latex and may include Teflon or other similar materials.

A preferred embodiment is shown in the illustration below.

The present invention is directed to a device useful in protecting percussion instruments from damage during play and storage of the instrument. Because the invention encompasses dual sizes, a wide range of protection is provided to any size drum

In yet another preferred embodiment of the invention, the illustration below provides details of the apparatus.

Advantages of the present invention over that known in the art include the ability to easily protect expensive pieces of percussion instruments while also allowing users of the device to store the instruments vertically, saving space for other equipment. In addition, the versatility of manufacturing materials provides fast production and simple marketing. The invention further provides the advantage of protection of the instrument while also allowing a user to play the drums if necessary, with no potential for damage to the drum head or overall drum head.

Although the invention has been described with reference to the above example, it will be understood that modifications and variations are encompassed within the spirit and scope of the invention. Accordingly, the invention is limited only by the following claims.

What is claimed is:

1. A protective drum stacking device comprising, a body portion made of a essentially a durable, semi-flexible material, and a top section which is molded to hold various sized drums in place, wherein, the top section is formed into peaks and valleys to hold the desired drum in place, wherein one or more of the protective drum stacking devices fit onto a drum head and allows placement of a second drum head thereon thus preventing any damage to either drum, during either storage or play of the drums.

2. The protective drum stacking device according to claim 1, comprising a body portion that is foam, plastic, silicone, rubber, synthetic rubber, Teflon or a thermoplastic elastomer.

3. The protective drum stacking device according to claim 1, wherein the body portion measures 3.97 inches in length, 1.25 inches in height, 0.50 inches peak to peak and 1.58 inches wide.

4. The protective drum stacking device according to claim 1, wherein the body portion measures 7.25 inches in length, 2.13 inches in height, 0.50 inches peak to peak and 1.58 inches wide.

5. A method of protecting a drum from damage wherein a protective drum stacking device is utilized comprising, a body portion made of a essentially a durable, semi-flexible material, and a top section which is molded to hold various sized drums in place, wherein, the top section is formed into peaks and valleys to hold the desired drum in place, wherein one or more of the protective drum stacking devices fit onto a drum head and allows placement of a second drum head thereon thus preventing any damage to either drum, during either storage or play of the drums.

6. The method of claim 5 wherein the protective drum stacking device encompasses various sizes to accommodate and protect different size drum heads.
